(19) United States
(12) Patent Application Publication
(10) Pub. No.: US 2021/0295660 A1
(43) Pub. Date: Sep. 23, 2021

(54) AUTOMATIC PAYMENT MACHINE AND AUTOMATIC PAYMENT MACHINE CONTROL METHOD

(71) Applicant: FUJITSU FRONTECH LIMITED, Tokyo (JP)

(72) Inventors: Mitsuo WATANABE, Inagi (JP); Nobuhiro MATSUI, Inagi (JP)

(73) Assignee: FUJITSU FRONTECH LIMITED, Tokyo (JP)

(21) Appl. No.: 17/340,168

(22) Filed: Jun. 7, 2021

Related U.S. Application Data
(63) Continuation of application No. PCT/JP2019/001835, filed on Jan. 22, 2019.

(51) Int. Cl. G07F 17/42; G10L 15/22; G06F 40/263; G06Q 10/02; G06Q 30/02; G06Q 50/12

(52) U.S. Cl. CPC G07F 17/42; G10L 15/22; G06F 40/263; G10L 2015/228; G06Q 30/0207; G06Q 50/12; G10L 2015/227; G06Q 10/02

(57) ABSTRACT

In an automatic payment machine, a voice processing section accepts an input by a voice from a user and acquires voice data. A reading section reads a passport, acquires image data, and acquires character information therefrom. A display acceptance section displays a screen and accepts an input. A key issuing section issues a room key. A control section specifies a voice recognition language corresponding to the voice on the basis of the voice data, specifies a nationality associated language corresponding to a nationality included in the character information, gives the display acceptance section, on the basis of the voice recognition language and the nationality associated language, instructions to perform a display, and gives the key issuing section, on the basis of the character information, the input the display acceptance section accepts, or an input the reading section accepts, instructions to issue the room key.

### CROSS-REFERENCE TO RELATED APPLICATION

This application is a continuation application of International Application PCT/JP2019/001835 filed on Jan. 22, 2019 which designated the U.S., the entire contents of which are incorporated herein by reference.

### FIELD

The embodiments discussed herein relate to an automatic payment machine and an automatic payment machine control method.

### BACKGROUND

In recent years a speech recognition technique has been used in various machines. Automatic teller machines installed in financial institutions, vending machines, and portable computers, such as smartphones, are known as machines which accommodate a voice input from a user.

For example, the following technique used in an automatic teller machine including a speech identification unit is known. A voice which prompts a user to make a response is outputted not only in Japanese but also in a plurality of languages and a language used by the user is identified by a language used for returning a response.

See, for example, Japanese Laid-open Patent Publication No. 2004-53825.

The conventional technique is able to deal with a plurality of languages depending on a voice response from a user of an automatic teller machine. However, to take a measure according to the other conditions is not considered.

As the number of foreign tourists increases, in recent years counter services at front desks in lodging facilities, such as hotels, have been provided in Japanese and English. However, as the number of lodgers' national origins increases, languages to be handled diversify. As a result, it is hoped that automatic payment machines used in lodging facilities will become still more multilingual.

### SUMMARY

According to an aspect of the embodiments, there is provided an automatic payment machine including: a voice interface which accepts an input by a voice from a customer and which acquires voice data; a reader which reads a passport, which acquires image data, and which acquires character information from the image data; a display panel which displays a screen and which accepts an input; a key issuing interface which issues a room key; and a processor which performs a process including specifying a voice recognition language corresponding to the voice on a basis of the voice data, specifying a nationality associated language corresponding to a nationality included in the character information, giving the display panel, on a basis of the voice recognition language and the nationality associated language, instructions to perform a display, and giving the key issuing interface, on a basis of the character information, the input the display panel accepts, or an input the reader accepts, instructions to issue the room key.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWING

FIG. 1 illustrates an example of an automatic payment machine according to a first embodiment.

FIG. 2 illustrates an example of an information processing system according to a second embodiment.

FIG. 3 illustrates an example of a hardware configuration of a lodging management server in the second embodiment.

FIG. 4 illustrates an example of a hardware configuration of an automatic payment machine in the second embodiment.

FIG. 5 illustrates an example of attendant management information in the second embodiment.

FIGS. 6A and 6B illustrate an example of a display screen on the automatic payment machine in the second embodiment (part 1).

FIGS. 7A and 7B illustrate an example of a display screen on the automatic payment machine in the second embodiment (part 2).

FIGS. 8A and 8B illustrate an example of a display screen on the automatic payment machine in the second embodiment (part 3).

FIGS. 9A and 9B illustrate an example of a display screen on the automatic payment machine in the second embodiment (part 4).

FIGS. 10A and 10B illustrate an example of a display screen on the automatic payment machine in the second embodiment (part 5).

FIGS. 11A to 11C illustrate an example of a display screen on the automatic payment machine in the second embodiment and a coupon ticket in the second embodiment.

FIG. 12 illustrates an example of a flow chart of a check-in acceptance process in the second embodiment (part 1).

FIG. 13 illustrates an example of a flow chart of a check-in acceptance process in the second embodiment (part 2).

FIG. 14 illustrates an example of a flow chart of a check-in acceptance process in the second embodiment (part 3).

FIG. 15 illustrates an example of a flow chart of a check-in acceptance process in the second embodiment (part 4).

FIG. 16 illustrates an example of a sequence of an attendant notification process in the second embodiment.

### DESCRIPTION OF EMBODIMENTS

Embodiments will now be described in detail by referring to the drawings.

### First Embodiment

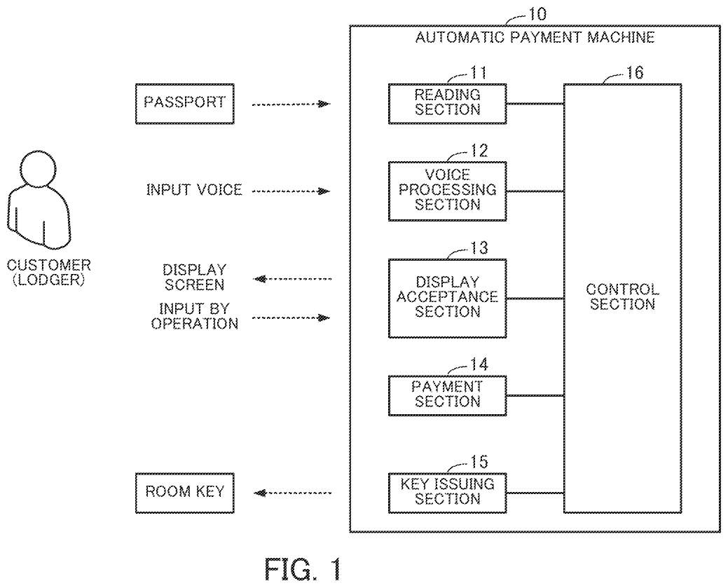

First an automatic payment machine according to a first embodiment will be described by the use of FIG. 1. FIG. 1 illustrates an example of an automatic payment machine according to a first embodiment.

An automatic payment machine 10 is used by a lodger (hereinafter stated as a customer) who uses a lodging facility, such as a hotel, for performing a lodging procedure (check-in). The automatic payment machine 10 may be installed not only in lodging facilities, such as hotels, but also in various facilities, such as airport lobbies, station and port waiting rooms, commercial buildings, office buildings, and theme parks.

The automatic payment machine 10 performs information communication with an information processing apparatus which manages reservation information regarding a lodging facility. The automatic payment machine 10 requests the information processing apparatus to make an inquiry about reservation information for the customer and acquires the reservation information. The reservation information includes a reservation number of the customer, a lodging date, payment information (information indicative of whether or not hotel charges have been paid), a room number, a room type, and the like. Information (passport number, a name, the date of birth, and a nationality) read from a passport may be used in place of the reservation number included in the reservation information. Furthermore, the automatic payment machine 10 performs information communication with an information processing apparatus which makes card payment. The automatic payment machine 10 communicates with the information processing apparatus via a network and performs a payment process by the use of a card. Each information processing apparatus is not illustrated.

The automatic payment machine 10 includes a reading section 11, a voice processing section 12, a display acceptance section 13, a payment section 14, a key issuing section 15, a control section 16, and the like. The automatic payment machine 10 also includes a ticket issuing section (not illustrated) which issues a coupon ticket.

The reading section 11 has the function of reading a passport image. For example, the reading section 11 is a scanner. The reading section 11 also has a character recognition function. On the basis of image data read from the passport, the reading section 11 performs character recognition on a machine readable zone of the passport and acquires the passport number, the nationality, the name, and the date of birth as character information. The reading section 11 also has the function of reading a bar code printed on a reservation slip or displayed on, for example, the customer's smartphone and acquiring the reservation number from the read bar code. The bar code may be a two-dimensional bar code.

The voice processing section 12 has the function of inputting and outputting a voice and is, for example, a microphone and a speaker. The voice processing section 12 accepts a voice input from the customer, acquires voice data, and outputs the voice data to the control section 16.

The display acceptance section 13 displays various pieces of information and accepts instructions inputted by the customer. For example, the display acceptance section 13 is a display and a touch panel fixed on an outer surface of the automatic payment machine 10. The display acceptance section 13 displays a screen for explaining a method for operating the automatic payment machine 10, lodging reservation information regarding the customer, a guidance screen, and the like.

The payment section 14 has the function of paying hotel charges of the lodging facility. For example, the payment section 14 includes a card acceptance unit and a cash acceptance unit. The card acceptance unit accepts a card (point card, a prepaid card, a credit card, or the like) from the customer who uses the automatic payment machine 10, reads information recorded on the card, communicates with an information processing apparatus, and performs a payment process. The cash acceptance unit has the function of accepting cash (banknote and a coin) paid by the user and ejecting change.

The key issuing section 15 has the function of accepting instructions from the control section 16 to issue a room key and issuing the room key. The room key is a card key used for opening and shutting an electronic lock on a door of a room in which the customer lodges.

The control section 16 controls the whole of the automatic payment machine 10 and is, for example, a processor. The control section 16 executes a program which realizes an automatic payment machine control method stored in s storage section and controls the automatic payment machine 10. Furthermore, the control section 16 has the function of recognizing, on the basis of the voice data acquired from the voice processing section 12, a voice and specifying a language (voice recognition language) corresponding thereto. In addition, the control section 16 accepts an input by operation via the display acceptance section 13 and controls the automatic payment machine 10 on the basis of input information which the control section 16 accepts.

The automatic payment machine 10 also includes the storage section (not illustrated) such as a hard disk drive (HDD) and various memories. In addition, the automatic payment machine 10 also includes a receipt section (not illustrated) which prints, for example, the amount of money paid on a receipt and which ejects the receipt.

A method by which the customer checks into the lodging facility by the use of the automatic payment machine 10 will now be described. It is assumed that the customer who uses the automatic payment machine 10 is a foreigner and that the customer needs to present the passport at the time of performing a lodging procedure in the lodging facility.

The display acceptance section 13 of the automatic payment machine 10 displays a screen which indicates that a voice input is accepted from the customer. The voice processing section 12 accepts a voice input from the customer, acquires voice data, and outputs the voice data to the control section 16.

The display acceptance section 13 displays a screen which gives instructions to lay the open passport on the reading section 11 for reading. The reading section 11 reads the passport, acquires image data, and acquires character information from the image data. The reading section 11 outputs the character information to the control section 16.

On the basis of the voice data, the control section 16 specifies a voice recognition language which is a language corresponding to a voice. The control section 16 specifies a nationality associated language which is a language corresponding to the nationality included in the character information. The automatic payment machine 10 stores in advance in the storage section information (nationality language association information) which associates a nationality with a language (official language of a country corresponding to the nationality), and specifies one or more languages (nationality associated languages) on the basis of the nationality acquired from the passport. If there are a plurality of official languages in a country corresponding to a nationality, then the plurality of official languages are nationality associated languages.

On the basis of a voice recognition language and a nationality associated language, the control section 16 gives the display acceptance section 13 instructions to perform display. For example, it is assumed that the customer speaks in Japanese and that a voice recognition language is “Japanese”. Furthermore, it is assumed that the nationality read from the customer's passport is “Canada” and that nationality associated languages are “English” and “French”. In this case, the control section 16 gives the display acceptance section 13 instructions to display a screen on which the three languages, that is to say, “Japanese,” “English,” and “French” are written together. The storage section included in the automatic payment machine 10 stores dictionaries of many languages and many screen display sentences as language information. On the basis of the language information stored in advance in the storage section, the control section 16 gives the display acceptance section 13 instructions to display a screen corresponding to a voice recognition language and a nationality associated language. On the basis of information acquired from a voice and a passport, the control section 16 deals in this way with a customer in a plurality of languages. In addition to giving instructions to display a screen in many languages, the control section 16 gives instructions to select one of voice recognition languages or nationality associated languages and display it on a screen.

The control section 16 verifies the lodging reservation information regarding the customer. If there is no problem, then the control section 16 gives the key issuing section 15 instructions to issue a room key. To be concrete, the control section 16 verifies the reservation information on the basis of the character information read from the passport, a reservation number which the display acceptance section 13 accepts, or the reservation number read from the bar code which the reading section 11 reads, and gives the key issuing section 15 instructions to issue a room key.

The control section 16 inquires of the information processing apparatus and verifies the reservation information inputted. If there is need to make a payment, then the control section 16 makes the display acceptance section 13 display a designation screen for performing a payment process. The payment section 14 accepts hotel charges paid by a card or in cash and makes a payment. After the payment section 14 informs the control section 16 that the payment is completed, the control section 16 gives instructions to issue a room key. When the control section 16 verifies the reservation information, the hotel charges may be transferred in advance. In this case, there is no need to make a payment. Accordingly, a payment process is not performed and instructions to issue a room key are given.

Labor or time which an attendant requires to deal with a customer in a lodging facility is reduced in this way by using the automatic payment machine 10. Furthermore, on the basis of a voice recognition language and a nationality associated language, the automatic payment machine 10 displays on the display acceptance section 13 a screen for giving the customer operation instructions and guidance. The automatic payment machine 10 displays a screen corresponding to a plurality of languages. As a result, it is easy for the customer to understand designation information displayed on the screen. Accordingly, the customer smoothly performs a procedure, a payment process, and the like at lodging time.

As has been described, the automatic payment machine 10 is multilingual.

### Second Embodiment

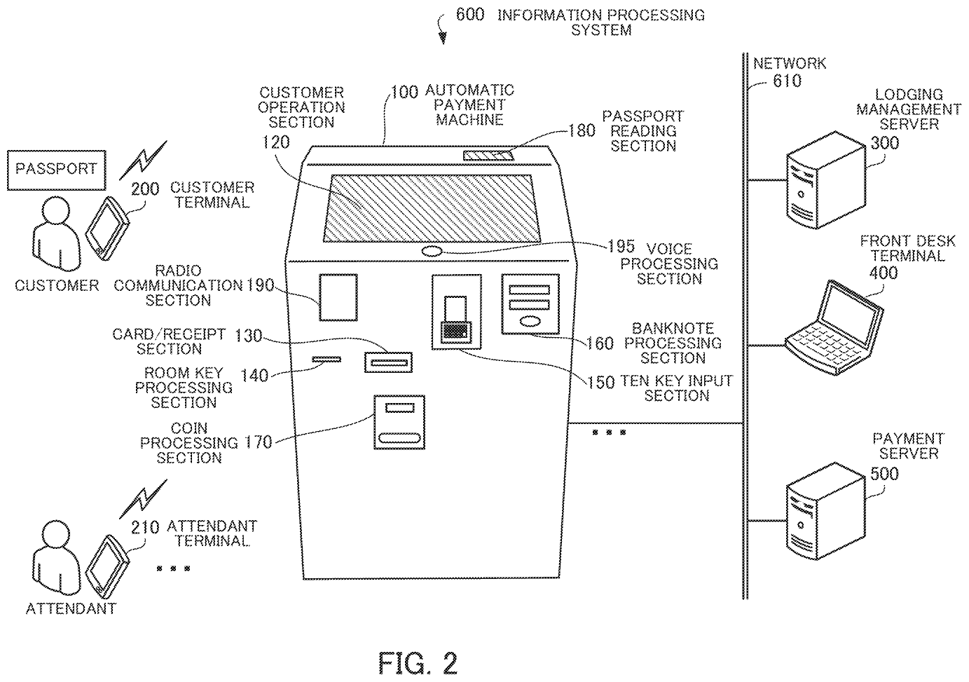

An information processing system to which the automatic payment machine 10 is applied will now be described as a second embodiment by the use of FIG. 2. FIG. 2 illustrates an example of an information processing system according to a second embodiment.

An information processing system 600 realizes a system by which a customer who uses a lodging facility, such as a hotel, performs a check-in procedure. It is assumed that the customer is a traveler from a foreign country and that the customer needs to present a passport at the time of using the lodging facility.

The information processing system 600 includes one or more automatic payment machines 100 (one of them is illustrated in FIG. 2) and various computers.

The automatic payment machine 100 is connected to a lodging management server 300 via a network 610. The lodging management server 300 performs information communication with an attendant terminal 210, a front desk terminal 400, and a payment server 500 via the network 610.

The automatic payment machine 100 has the function of accepting a check-in from the customer via a voice input or an input device, displaying a multilingual screen, paying hotel charges, and issuing a room key. The automatic payment machine 100 has the function of receiving money paid in cash or by other methods.

The automatic payment machine 100 includes a customer operation section 120, a card/receipt section 130, a room key processing section 140, a ten key input section 150, a banknote processing section 160, a coin processing section 170, a passport reading section 180, a radio communication section 190, and a voice processing section 195.

The customer operation section 120 has a display and a touch panel, gives guidance to the customer as to operation, and accepts instructions.

When payment is made by the use of a card such as a point card or a credit card, the card/receipt section 130 reads information of the inserted card. Furthermore, when the payment ends, the card/receipt section 130 prints and ejects a receipt.

The ten key input section 150 has buttons for inputting figures and the like and accepts instructions from the customer (user) in conjunction with the touch panel of the customer operation section 120. For example, the ten key input section 150 accepts an input such as a personal identification number for authenticating the card or the like, a selection from choices displayed on the customer operation section 120, or the like. When money is received or paid, the banknote processing section 160 receives or pays a banknote. The banknote processing section 160 has a short-range camera (not illustrated) which photographs the inlet or outlet of a banknote and its vicinity. Accordingly, it is possible to videotape a state in which a banknote is received or paid. When money is received or paid, the coin processing section 170 receives or pays a coin.

The passport reading section 180 has the function of a scanner and acquires image information by scanning the whole of the passport laid face down. Furthermore, the passport reading section 180 has the function of character recognition. The passport reading section 180 performs character recognition on an OCR region (internationally standardized machine readable zone including two lines of 44 characters each) of the passport and acquires a passport number, a nationality, a name, and the date of birth as text data. Furthermore, the passport reading section 180 has the function of reading a bar code (which may be a two-dimensional bar code). The passport reading section 180 has the function of reading a bar code displayed on a reservation slip or a customer terminal 200 and reading a reservation number for identifying reservation information in the lodging facility.

The radio communication section 190 has a communication function. For example, the radio communication section 190 has the function of contactless radio communication such as near field communication (NFC). The automatic payment machine 100 communicates with the customer terminal 200 or the like via the radio communication section 190. The voice processing section 195 has the function of inputting and outputting a voice and has the function of, for example, a speaker and a microphone.

The customer terminal 200 is a computer used by a user and is a smartphone, a tablet computer, or the like. The customer terminal 200 has the function of executing an application program (hereinafter stated as an application) used for making a payment by the use of the automatic payment machine 100. The customer terminal 200 has the function of performing information communication with various pieces of apparatus.

The attendant terminal 210 is a computer used by an attendant in the lodging facility and is a smartphone, a tablet computer, or the like. The attendant terminal 210 has the function of displaying information of which the lodging management server 300 informs the attendant terminal 210 and the function of transmitting information to the lodging management server 300.

The lodging management server 300 is a computer which transmits information to or receives information from the automatic payment machine 100, on which a payment process and a customer authentication process using the automatic payment machine 100 are performed, and on which a program having the function of managing the automatic payment machine 100 is executed. Furthermore, the lodging management server 300 receives various pieces of information from the automatic payment machine 100 and stores them in a storage section of a database, a disk, or the like. The database (not illustrated) is a storage unit which stores various pieces of information and is accessed by the lodging management server 300. In addition, the lodging management server 300 has the function of transmitting to the front desk terminal 400 a situation where the automatic payment machine 100 is used or a situation where instructions to call an attendant are given and the function of transmitting to the payment server 500 instructions to perform a transfer processing.

The front desk terminal 400 is a computer used by an attendant at a front desk of the lodging facility and having the function of performing information communication with the lodging management server 300. The payment server 500 is a computer having the function of performing a payment process accepted via the automatic payment machine 100. The payment server 500 may be replaced with a server installed in another financial institution.

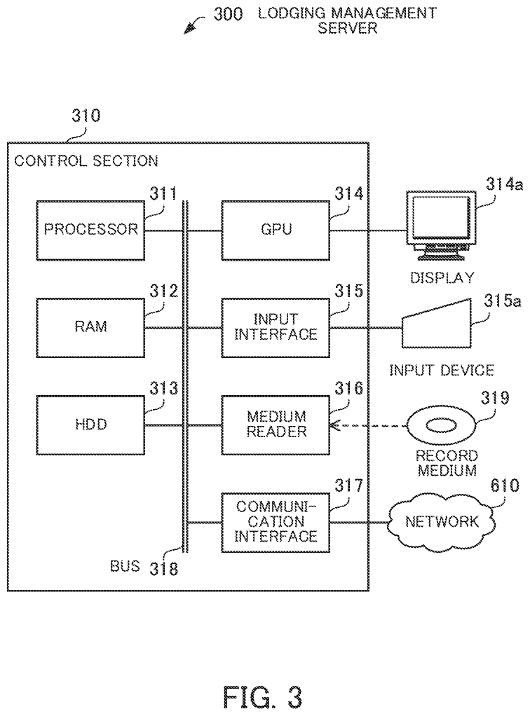

The lodging management server in the second embodiment will now be described by the use of FIG. 3. FIG. 3 illustrates an example of a hardware configuration of the lodging management server in the second embodiment.

The lodging management server 300 includes a control section 310. The control section 310 includes a processor 311, a random access memory (RAM) 312, an HDD 313, a graphics processing unit (GPU) 314, an input interface 315, a medium reader 316, and a communication interface 317. The whole of the lodging management server 300 is controlled by the processor 311. The RAM 312 and a plurality of peripheral devices are connected to the processor 311 via a bus 318. The processor 311 may be a multiprocessor. The processor 311 is a central processing unit (CPU), a micro processing unit (MPU), a digital signal processor (DSP), an application specific integrated circuit (ASIC), a programmable logic device (PLD), or the like. Furthermore, the processor 311 may be a combination of two or more of a CPU, an MPU, a DSP, an ASIC, and a PLD.

The RAM 312 is used as a main storage of the lodging management server 300. The RAM 312 temporarily stores at least part of an operating system (OS) program or an application program executed by the processor 311. In addition, the RAM 312 stores various pieces of data which the processor 311 needs for performing a process.

The plurality of peripheral devices connected to the bus 318 are the HDD 313, the GPU 314, the input interface 315, the medium reader 316, and the communication interface 317.

The HDD 313 magnetically writes data to and reads out data from a built-in disk. The HDD 313 is used as an auxiliary storage of the lodging management server 300. The HDD 313 stores the OS program, application programs, and various pieces of data. A solid state drive (SSD) may be used in place of the HDD 313. A semiconductor memory, such as a flash memory, may be used as an auxiliary storage.

GPU 314 outputs an image to a display 314a connected to the lodging management server 300 in accordance with an instruction from the processor 311. Any kind of display may be used as the display 314a. For example, a cathode ray tube (CRT) display, a liquid crystal display (LCD), a plasma display, or an organic electro-luminescence (OEL) display may be used as the display 314a.

The input interface 315 acquires an input signal from an input device 315a connected to the lodging management server 300 and outputs it to the processor 311. Any kind of input device may be used as the input device 315a. For example, a mouse, a touch panel, a touch pad, a track ball, a keyboard, a remote controller, or a button switch may be used as the input device 315a. Furthermore, two or more kinds of input devices may be connected to the lodging management server 300.

The medium reader 316 is a reader which reads a program or data recorded in a record medium 319. A magnetic disk, an optical disk, a magneto-optical disk (MO), a semiconductor memory, or the like is used as the record medium 319. A magnetic disk is a flexible disk (FD), an HDD, or the like. An optical disk is a compact disc (CD), a digital versatile disc (DVD), or the like.

For example, the medium reader 316 copies a program or data read from the record medium 319 to another record medium such as the RAM 312 or the HDD 313. For example, a read program is executed by the processor 311. The record medium 319 may be a portable record medium and be used for distributing a program or data. In addition, the record medium 319 or the HDD 313 may be referred to as a computer-readable record medium.

The communication interface 317 is connected to the network 610. The communication interface 317 transmits data to or receives data from another computer, storage unit, or communication device. The network 610 may be a wired network or a radio network.

The processing functions of the lodging management server 300 in the second embodiment are realized by adopting the above hardware configuration. Furthermore, the front desk terminal 400, the payment server 500, the customer terminal 200, or the attendant terminal 210 in the second embodiment is also realized by the hardware configuration of the lodging management server 300 illustrated in FIG. 3.

The above hardware configuration is an example. A combination of components may be determined properly. With the customer terminal 200 and the attendant terminal 210, for example, the display 314a and the body may be integrally formed as a liquid crystal panel and the input device 315a and the body may be integrally formed as a touch panel. Furthermore, a needless component may be eliminated from the above components.

For example, the lodging management server 300 realizes the processing functions in the second embodiment by executing a program recorded in a computer-readable record medium. The program in which the contents of processes performed by the lodging management server 300 are described is recorded in various record media. For example, the program executed by the lodging management server 300 may be stored in the HDD 313. The processor 311 loads into the RAM 312 at least part of the program stored in the HDD 313 and executes the program. In addition, the program executed by the lodging management server 300 may be recorded in a portable record medium such as an optical disk, a memory unit, or a memory card. After the program stored in a portable record medium is installed in the HDD 313, for example, under the control of the processor 311, it is executed. Furthermore, the processor 311 may read the program directly from a portable record medium and execute it.

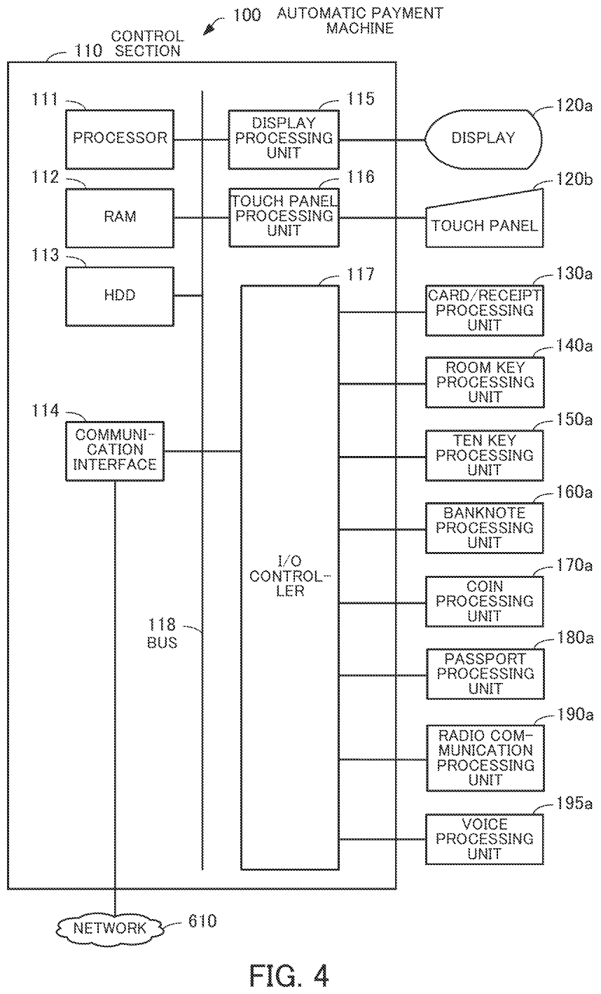

The automatic payment machine in the second embodiment will now be described by the use of FIG. 4. FIG. 4 illustrates an example of a hardware configuration of the automatic payment machine in the second embodiment.

The automatic payment machine 100 includes a control section 110, a display 120a, a touch panel 120b, a card/receipt processing unit 130a, a room key processing unit 140a, a ten key processing unit 150a, a banknote processing unit 160a, a coin processing unit 170a, a passport processing unit 180a, a radio communication processing unit 190a, and a voice processing unit 195a.

The control section 110 includes a processor 111, a RAM 112, an HDD 113, a communication interface 114, a display processing unit 115, a touch panel processing unit 116, and an input/output (I/O) controller 117 which are connected to one another via a bus 118.

The processor 111 controls the whole operation of the automatic payment machine 100. The processor 111 is a CPU, an MPU, or the like. The processor 111 stores card information (card brand name or a card handling financial institution name, a card number, and the like) acquired via the card/receipt processing unit 130a in a storage unit such as the HDD 113. Furthermore, the processor 111 transmits to the lodging management server 300 information read from a card.

The RAM 112 temporarily stores at least part of an OS program or an application program executed by the processor 111. In addition, the RAM 112 stores various pieces of data which the processor 111 needs for performing a process.

The OS program, application programs, payment information, and the like are stored in the HDD 113. Furthermore, another storage device, such as an SSD, may be used in place of the HDD 113.

The communication interface 114 is connected to the external network 610 and transmits data to or receives data from the lodging management server 300 or the like. In addition, the communication interface 114 transmits a personal identification number, payment information, or the like to or receives a personal identification number, payment information, or the like from the lodging management server 300.

The display 120a is connected to the display processing unit 115. The display 120a and the touch panel 120b make up the customer operation section 120. The display processing unit 115 displays various pieces of information including guidance as to operation on a screen of the display 120a under the control of the processor 111.

The touch panel 120b is connected to the touch panel processing unit 116. The touch panel 120b is formed in a layer over the display 120a. The touch panel processing unit 116 detects a position on a screen of the touch panel 120b which a finger of the customer touches or approaches and informs the processor 111 of the position.

The card/receipt processing unit 130a, the room key processing unit 140a, the ten key processing unit 150a, the banknote processing unit 160a, the coin processing unit 170a, the passport processing unit 180a, the radio communication processing unit 190a, and the voice processing unit 195a are connected to the I/O controller 117. Under the control of the processor 111, the I/O controller 117 informs each unit connected thereto of instructions from the processor 111 and transmits information acquired from each unit to the processor 111 via the bus 118.

The card/receipt processing unit 130a is located in the card/receipt section 130 and reads information recorded on a card. The card/receipt processing unit 130a may include a magnetic information reader, a contactless integrated circuit (IC) card reader, or another reader. The card/receipt processing unit 130a prints the contents of a payment and ejects them as a statement slip (receipt).

The room key processing unit 140a is located in the room key processing section 140 and has the function of issuing a room key card. A room key has the function of shutting and opening an electronic lock on a door of a guest room in a lodging facility. The room key processing unit 140a has the function of setting a room key card according to a number of a room in a lodging facility, the date and hour of lodging, and the like.

The ten key processing unit 150a is located in the ten key input section 150 and outputs information regarding a button which the customer presses down. Information regarding a button which the customer presses down may include a personal identification number, information used for a payment process, or the like.

The banknote processing unit 160a is located in the banknote processing section 160 and controls receiving and paying a banknote and opening and closing a door in accordance with instructions from the processor 111. Furthermore, the banknote processing unit 160a also controls imaging by the short-range camera included in the banknote processing section 160. The coin processing unit 170a is located in the coin processing section 170 and controls receiving and paying a coin and opening and closing a door in accordance with instructions from the processor 111.

The passport processing unit 180a is located in the passport reading section 180 and has the function of reading a passport or a bar code. For example, the passport processing unit 180a acquires as image information the whole of the passport which the customer lays face down on the passport reading section 180. Furthermore, the passport processing unit 180a performs character recognition on the OCR region of the passport and acquires character information (passport number, a nationality, and the like). In addition, the passport processing unit 180a reads a screen on the customer terminal 200 on which the customer displays a two-dimensional bar code as a reservation confirmation slip and reads a reservation number from the two-dimensional bar code.

The radio communication processing unit 190a is located in the radio communication section 190 and has the function of communicating with a device such as the customer terminal 200. For example, the radio communication processing unit 190a may perform a process for paying, for example, lodging expenses (hotel charges, food and drink charges, service charges, taxes, and the like) by performing payment information communication with the customer terminal 200.

The voice processing unit 195a is located in the voice processing section 195 has the function of outputting a voice and accepting a voice input. Furthermore, the voice processing unit 195a recognizes a language used by the customer on the basis of a voice inputted.

The processing functions of the automatic payment machine 100 in the second embodiment are realized by adopting the above hardware configuration. The automatic payment machine 10 according to the first embodiment is also realized by adopting the hardware configuration of the automatic payment machine 100 illustrated in FIG. 4. The above configuration is an example and a combination of components of the automatic payment machine 100 may be determined properly.

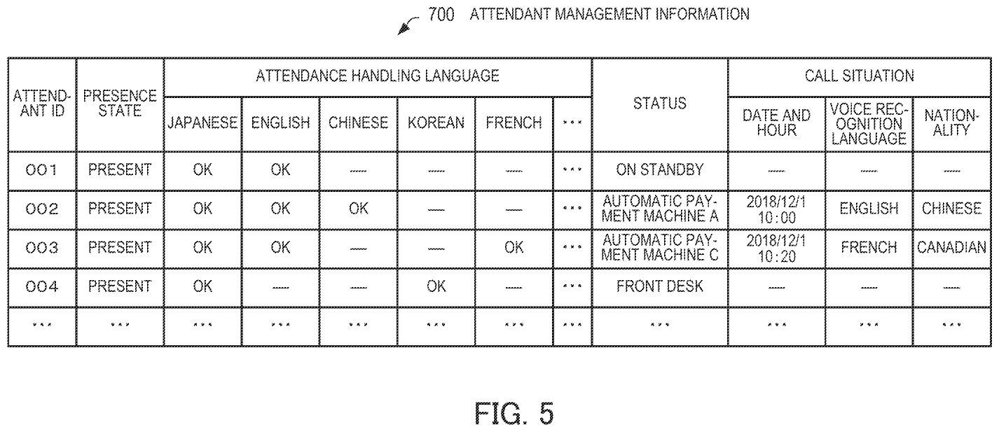

An example of attendant management information in the second embodiment will now be described by the use of FIG. 5. FIG. 5 illustrates an example of attendant management information in the second embodiment.

Attendant management information 700 is used for managing an attendant who deals with a customer in the lodging facility. The attendant management information 700 includes information set in advance by a system administrator and information acquired from the automatic payment machine 100 and the attendant terminal 210. The attendant management information 700 is managed by the lodging management server 300 and is stored in a storage unit such as a database or the HDD 313.

The attendant management information 700 includes Attendant ID, Presence State, Attendance Handling Language, Status, and Call Situation items.

Identification information (attendant ID) for identifying an attendant is registered in the Attendant ID item. A presence state of an attendant is registered in the Presence State item. For example, if an attendant is present, then “Present” is registered in the Presence State item. If an attendant has left the office, then “Left the Office” is registered in the Presence State item. If an attendant is on vacation, then “Vacation” or the like is registered in the Presence State item. The lodging management server 300 receives a presence state transmitted from the attendant terminal 210 and registers it in the attendant management information 700.

A language which an attendant corresponding to attendant ID is able to handle to deal with a customer is registered in the Attendance Handling Language item. If an attendant is able to handle a language (Japanese, English, Chinese, Korean, French, or the like), then “OK” is registered in a subitem corresponding to the language included in the Attendance Handling Language item. If an attendant handles a language (Japanese, English, Chinese, Korean, French, or the like), then “OK” is registered in a subitem corresponding to the language included in the Attendance Handling Language item. If an attendant does not handle a language (Japanese, English, Chinese, Korean, French, or the like), then “-” is registered in a subitem corresponding to the language included in the Attendance Handling Language item. Information included in the Attendance Handling Language item is registered in advance by the system administrator or the like.

A status of an attendant is registered in the Status item. If an attendant is on standby in an office, then “On Standby” is registered in the Status item. If an attendant is, for example, explaining the operation of the automatic payment machine 100 to a customer, then identification information (payment machine identification information) for identifying an automatic payment machine is registered in the Status item. For example, if an attendant is explaining to a customer the operation of an automatic payment machine, of a plurality of automatic payment machines included in the information processing system 600, whose payment machine identification information is “A,” then “Automatic Payment Machine A” is registered in the Status item. The lodging management server 300 receives a status of an attendant from the attendant terminal 210 and registers it in the attendant management information 700. Furthermore, if an attendant is at work at the front desk, then “Front Desk” is registered in the Status item. The lodging management server 300 receives from the front desk terminal 400 attendant ID of an attendant who logs in to the front desk terminal 400, and registers “Front Desk” in the Status item corresponding to the attendant ID.

When determined time elapses (time-out occurs) while a customer is operating the automatic payment machine 100, an attendant is called. A situation at this time is registered in the Call Situation item. The Call Situation item includes Date and Hour, Voice Recognition Language, and Nationality subitems. The date and hour at which a time-out occurs for the automatic payment machine 100 are registered in the Date and Hour subitem. A language acquired by performing voice recognition on the customer with the automatic payment machine 100 for which a time-out occurs is registered in the Voice Recognition Language subitem. A nationality read from a passport with the automatic payment machine 100 for which a time-out occurs is registered in the Nationality subitem.

Entries included in the attendant management information 700 will now be described concretely. The following information registered in the attendant management information 700 is taken as an example. “002” is registered in the Attendant ID item, “present” is registered in the Presence State item, “OK” is registered in the Japanese, English, and Chinese subitems of the Attendance Handling Language item, “automatic payment machine A” is registered in the Status item, “2018/12/1 10:00” is registered in the Date and Hour subitem of the Call Situation item, “English” is registered in the Voice Recognition Language subitem of the Call Situation item, and “Chinese” is registered in the Nationality subitem of the Call Situation item.

The above information indicates that the presence state of an attendant whose attendant ID is “002” is “present” and that it is possible (“OK”) for the attendant whose attendant ID is “002” to deal with a customer in “Japanese,” “English,” and “Chinese”. Furthermore, the above information indicates that the attendant whose attendant ID is “002” is explaining the operation of the “automatic payment machine A” to a customer. In addition, the above information indicates that a time-out occurs for the “automatic payment machine A” at “2018/12/1 10:00”. Moreover, the above information indicates that a language acquired by performing voice recognition with the “automatic payment machine A” is “English” and that a nationality read from a passport is “Chinese”.

A state of an attendant is managed in this way in the attendant management information 700. By doing so, the manager of the lodging facility grasps the working state of an attendant or a situation where an attendant deals with a customer for the automatic payment machine 100. Furthermore, the lodging management server 300 accumulates as history information a status and a call situation included in the attendant management information 700. By doing so, information (date and hour, a voice recognition language, and a nationality) regarding a customer for whom a time-out occurs is analyzed. On the basis of an analysis result, the manager and attendants of the lodging facility improve customer dealing in the lodging facility. In addition, on the basis of the analysis result, the system administrator or the like in the lodging facility may set a default language displayed on the customer operation section 120 of the automatic payment machine 100.

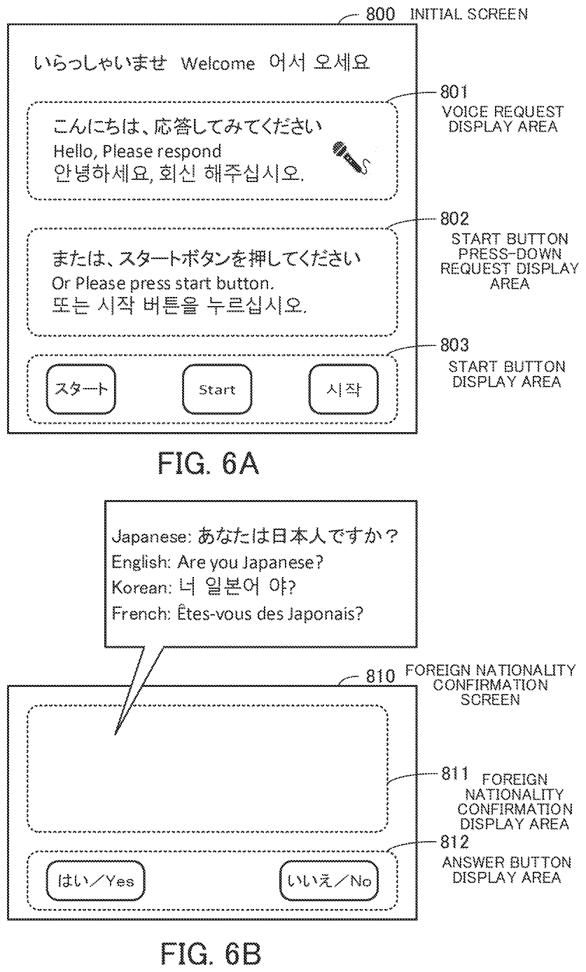

An example of a screen which the automatic payment machine 100 in the second embodiment displays will now be described by the use of FIGS. 6A and 6B. FIGS. 6A and 6B illustrate an example of a display screen on the automatic payment machine in the second embodiment (part 1).

FIG. 6A illustrates an example of an initial screen 800 displayed on the customer operation section 120 of the automatic payment machine 100. The initial screen 800 is a screen which the automatic payment machine 100 first presents on the customer operation section 120 to a customer that checks in. The initial screen 800 includes a voice request display area 801, a start button press-down request display area 802, and a start button display area 803.

The voice request display area 801 includes display which requests the customer to produce a voice output. For example, the sentence “Hello, please respond.” is displayed on the voice request display area 801.

The start button press-down request display area 802 includes display which requests, if the customer does not produce a voice output, the customer to press down a start button. For example, the sentence “Or please press start button.” is displayed on the start button press-down request display area 802.

Start buttons displayed in many languages are displayed on the start button display area 803. Buttons on which a word that means a start is mentioned are displayed according to languages on the start button display area 803. As a result, the automatic payment machine 100 recognizes a language corresponding to a button which the customer presses down. If the automatic payment machine 100 does not accept a voice from the customer, then the automatic payment machine 100 treats as a substitute for a voice recognition language a language corresponding to a button which the customer presses down.

The initial screen 800 is displayed in three languages, that is to say, in Japanese, English, and Korean. However, the initial screen 800 is a simple example. The initial screen 800 may be displayed in other languages (French, German, Chinese, and the like). A display language (default display language) on the initial screen 800 may be changed by the system administrator or the like by setting a language.

The automatic payment machine 100 accepts an input via the customer operation section 120 on which the initial screen 800 is displayed and the voice processing section 195. If the automatic payment machine 100 accepts a voice input via the voice processing section 195, then the automatic payment machine 100 specifies a language (voice recognition language) by voice recognition. Furthermore, if the automatic payment machine 100 detects via the customer operation section 120 that a button displayed on the start button display area 803 is pressed down, then the automatic payment machine 100 recognizes a language displayed on the detected button.

FIG. 6B illustrates an example of a foreign nationality confirmation screen 810 displayed on the customer operation section 120 of the automatic payment machine 100. Whether the customer is of foreign nationality or not is confirmed on the foreign nationality confirmation screen 810. The foreign nationality confirmation screen 810 includes a foreign nationality confirmation display area 811 and an answer button display area 812.

The foreign nationality confirmation display area 811 includes display which confirms whether or not the customer is of foreign nationality.

For example, the sentence “Are you a Japanese?” is displayed on the foreign nationality confirmation display area 811. If the automatic payment machine 100 is installed in Japan, then the display included in the foreign nationality confirmation display area 811 is taken as an example. The contents of display are changed according to countries in which the automatic payment machine 100 is installed. For example, if the automatic payment machine 100 is installed in America, then the above sentence is changed to the sentence “Are you an American?”. If the automatic payment machine 100 is installed in England, then the above sentence is changed to the sentence “Are you an Englishman (Englishwoman)?”.

Buttons for making an answer to the question as to whether or not the customer is of foreign nationality are displayed on the answer button display area 812. If the customer is of foreign nationality, then the customer presses down a button which is indicative that the customer is of foreign nationality. If the customer is not of foreign nationality, then the customer presses down a button which is indicative that the customer is not of foreign nationality. If the automatic payment machine 100 is installed in Japan and the sentence “Are you a Japanese?” is displayed on the foreign nationality confirmation display area 811, then a button which is indicative that the customer is of foreign nationality is a “No” button. Furthermore, if the automatic payment machine 100 is installed in Japan and the sentence “Are you a Japanese?” is displayed on the foreign nationality confirmation display area 811, then a button which is indicative that the customer is not of foreign nationality is a “Yes” button.

A language, of Japanese, English, Korean, French, and the like, corresponding to a voice recognition language acquired at the time of displaying the initial screen 800 is displayed on the foreign nationality confirmation display area 811. For example, if the automatic payment machine 100 recognizes French as a voice recognition language, then the automatic payment machine 100 performs in French on the foreign nationality confirmation display area 811 display which confirms whether or not the customer is of foreign nationality.

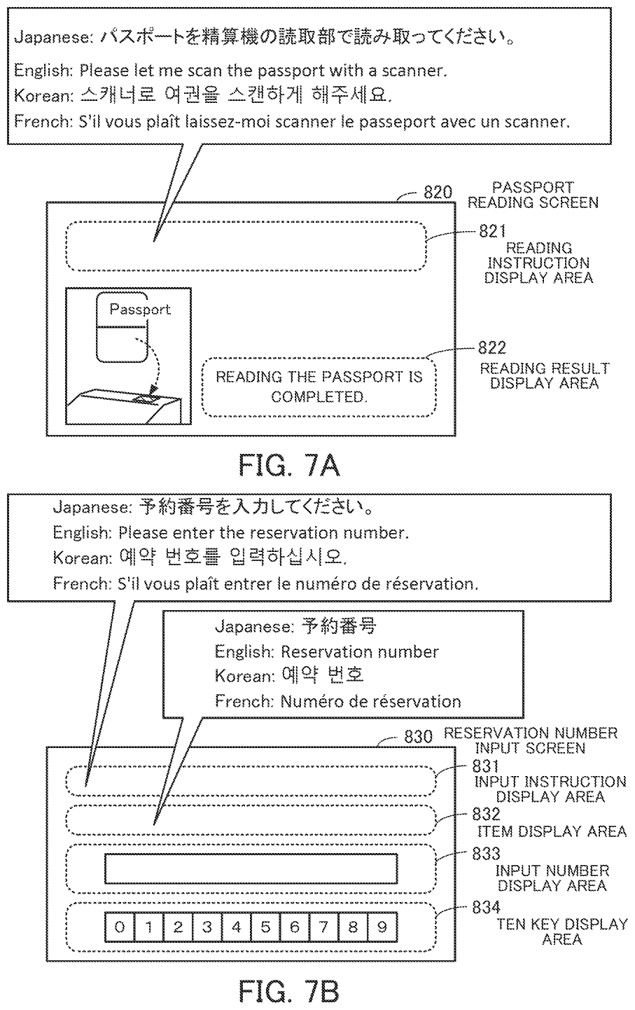

The four languages (Japanese, English, Korean, and French) displayed in a balloon indicative of a display area are a simple example of a language displayed on a screen. A voice recognition language is selected from among a plurality of languages and is displayed. The same applies to description of other screens. From FIG. 7B, a language is selected and displayed on the basis of a nationality acquired from a voice recognition language or a passport. One language may be displayed on the automatic payment machine 100 or a plurality of languages may be displayed on the automatic payment machine 100.

An example of a screen which the automatic payment machine 100 in the second embodiment displays will now be described by the use of FIGS. 7A and 7B. FIGS. 7A and 7B illustrate an example of a display screen on the automatic payment machine in the second embodiment (part 2).

FIG. 7A illustrates an example of a passport reading screen 820 displayed on the customer operation section 120 of the automatic payment machine 100. The passport reading screen 820 prompts a customer of foreign nationality to read a passport. The passport reading screen 820 includes a reading instruction display area 821 and a reading result display area 822.

Words for giving the customer instructions to lay the passport on the passport reading section 180 of the automatic payment machine 100 and to make the passport reading section 180 read the passport are displayed on the reading instruction display area 821. For example, the sentence “Please let me scan the passport with a scanner.” is displayed in a selected language on the reading instruction display area 821.

The reading result of the passport is displayed on the reading result display area 822. If the automatic payment machine 100 succeeds in acquiring a passport image and performing character recognition, then the automatic payment machine 100 performs on the reading result display area 822 display to the effect that reading the passport is completed. Furthermore, if the automatic payment machine 100 does not acquire a passport image and does not perform character recognition, then the automatic payment machine 100 performs on the reading result display area 822 display to the effect that reading the passport is unsuccessful and that the customer needs to lay the passport again on the passport reading section 180.

The sentence “Reading the passport is completed.” is displayed in Japanese on the reading result display area 822. However, this display is a simple example. For example, if the automatic payment machine 100 recognizes French as a voice recognition language, then the automatic payment machine 100 performs display in French on the reading result display area 822.

The passport reading screen 820 may include not only the reading instruction display area 821 and the reading result display area 822 but also a graphic description of the operation of the automatic payment machine 100.

FIG. 7B illustrates an example of a reservation number input screen 830 displayed on the customer operation section 120 of the automatic payment machine 100.

The reservation number input screen 830 prompts the customer to input a reservation number. The reservation number input screen 830 includes an input instruction display area 831, an item display area 832, an input number display area 833, and a ten key display area 834.

Instructions to input a reservation number are displayed on the input instruction display area 831. An item name inputted is displayed on the item display area 832. On the basis of a nationality acquired from a voice recognition language or a passport, a language is selected and displayed on the input instruction display area 831 and the item display area 832.

If a figure button is pressed down on the ten key display area 834, then a figure corresponding to the button pressed down is displayed on the input number display area 833. Figure button from “0” through “9” are displayed on the ten key display area 834. The automatic payment machine 100 detects that a figure button is pressed down, displays a figure corresponding to the button pressed down on the input number display area 833, recognizes figures which it accepts as a reservation number, and transmits the reservation number to the lodging management server 300.

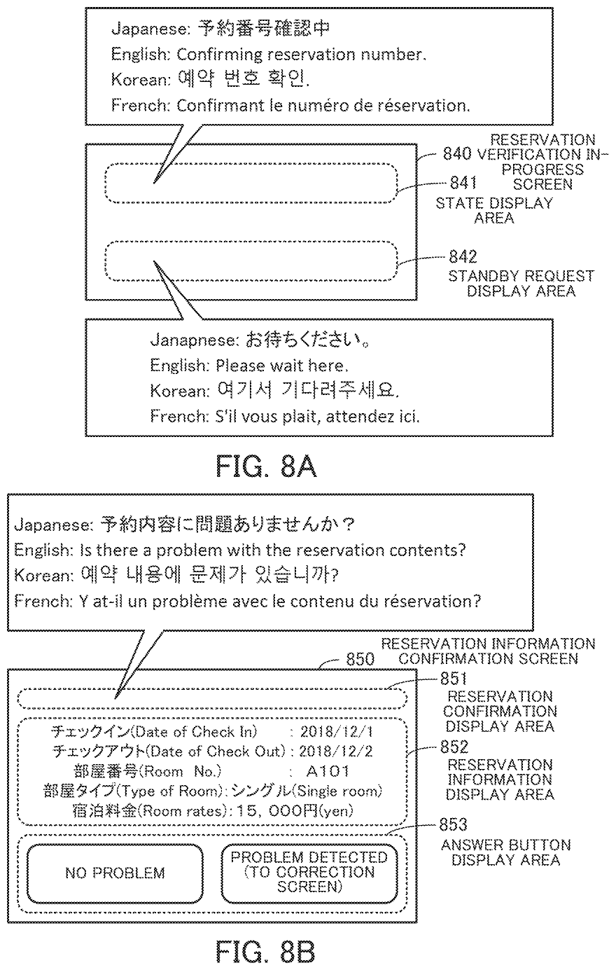

An example of a screen which the automatic payment machine 100 in the second embodiment displays will now be described by the use of FIGS. 8A and 8B. FIGS. 8A and 8B illustrate an example of a display screen on the automatic payment machine in the second embodiment (part 3).

FIG. 8A illustrates an example of a reservation verification in-progress screen 840 displayed on the customer operation section 120 of the automatic payment machine 100. The reservation number which the automatic payment machine 100 accepts is transmitted to the lodging management server 300 and is verified. The reservation verification in-progress screen 840 is displayed during this time.

The reservation verification in-progress screen 840 includes a state display area 841 and a standby request display area 842. A state in which confirmation of the reservation number by the automatic payment machine 100 is in progress is displayed on the state display area 841. For example, the sentence “Confirming reservation number.” is displayed on the state display area 841. Display to the effect that the customer is requested to wait until confirmation of the reservation number ends is performed on the standby request display area 842. For example, the sentence “Please wait here.” is displayed on the standby request display area 842.

On the basis of the nationality acquired from the voice recognition language or the passport, a language is selected and displayed on the state display area 841 and the standby request display area 842.

FIG. 8B illustrates an example of a reservation information confirmation screen 850 displayed on the customer operation section 120 of the automatic payment machine 100. Reservation information corresponding to the reservation number which the automatic payment machine 100 accepts is confirmed on the reservation information confirmation screen 850. The reservation information confirmation screen 850 includes a reservation confirmation display area 851, a reservation information display area 852, and an answer button display area 853.

Words for prompting the customer to confirm the reservation information are displayed on the reservation confirmation display area 851. For example, the sentence “Is there a problem with the reservation contents?” or the sentence “Is there a problem with the contract contents?” is displayed on the reservation confirmation display area 851. The reservation information corresponding to the reservation number inputted is displayed on the reservation information display area 852. For example, a lodging period (dates of a check-in and a check-out, a room number, a room type, and hotel charges are displayed on the reservation information display area 852.

Buttons for making an answer to the question as to whether or not there is a problem with the reservation information are displayed on the answer button display area 853. If there is no problem with the reservation information, then the customer presses down a “No Problem” button. If there is a problem with the reservation information, then the customer presses down a “Problem Detected (to Correction Screen)” button. If the customer presses down the “Problem Detected (to Correction Screen)” button, then the automatic payment machine 100 displays on the customer operation section 120 a reservation correction screen (not illustrated) which accepts a correction.

On the basis of the nationality acquired from the voice recognition language or the passport, a language is selected and displayed on the reservation confirmation display area 851, the reservation information display area 852, and the answer button display area 853.

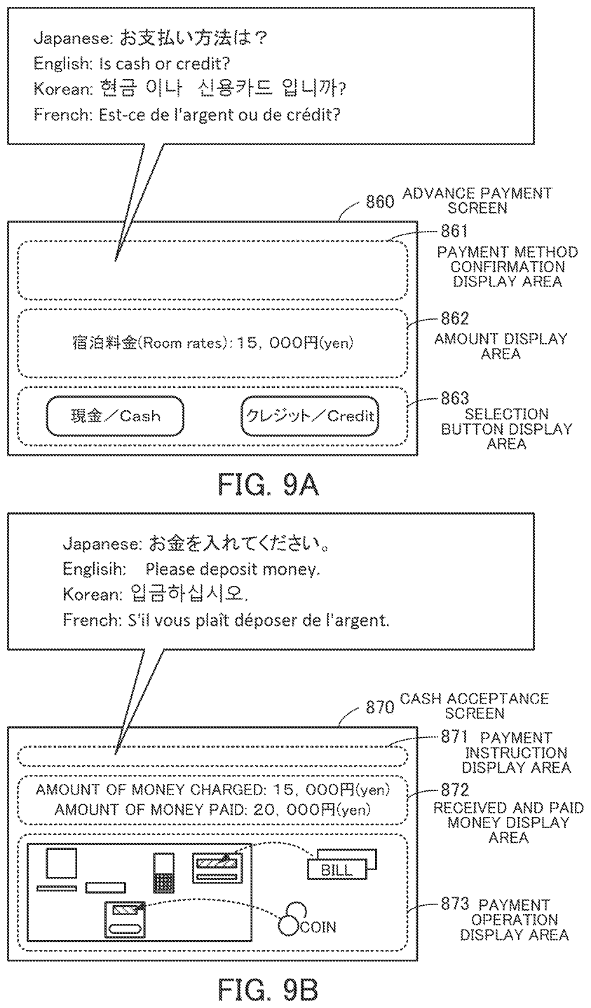

An example of a screen which the automatic payment machine 100 in the second embodiment displays will now be described by the use of FIGS. 9A and 9B. FIGS. 9A and 9B illustrate an example of a display screen on the automatic payment machine in the second embodiment (part 4).

FIG. 9A illustrates an example of an advance payment screen 860 displayed on the customer operation section 120 of the automatic payment machine 100. A payment method by the customer is confirmed on the advance payment screen 860. The advance payment screen 860 includes a payment method confirmation display area 861, an amount display area 862, and a selection button display area 863.

Confirmation of a payment method is displayed on the payment method confirmation display area 861. For example, the sentence “Is cash or credit?” is displayed on the payment method confirmation display area 861. Hotel charges are displayed on the amount display area 862. Buttons for selecting a payment method are displayed on the selection button display area 863. For example, a “Cash” button, a “Credit” button, and the like are displayed on the selection button display area 863. These are a simple example of buttons for selecting a payment method. A button for selecting another payment method (loyalty program, a complimentary ticket, virtual currency, or the like) may be displayed on the selection button display area 863.

On the basis of the nationality acquired from the voice recognition language or the passport, a language is selected and displayed on the payment method confirmation display area 861.

FIG. 9B illustrates an example of a cash acceptance screen 870 displayed on the customer operation section 120 of the automatic payment machine 100. If the automatic payment machine 100 accepts a payment in cash, then the cash acceptance screen 870 prompts the customer to pay cash, and explains the operation. The cash acceptance screen 870 includes a payment instruction display area 871, a received and paid money display area 872, and a payment operation display area 873. The payment instruction display area 871 includes display which gives the customer instructions to pay cash. For example, the sentence “Please deposit money.” is displayed on the payment instruction display area 871. The received and paid money display area 872 displays the amount of money charged as hotel charges and the amount of money paid into the automatic payment machine 100. The payment operation display area 873 displays positions in which cash is put and a graphic explanation of the operation.

On the basis of the nationality acquired from the voice recognition language or the passport, a language is selected and displayed on the payment instruction display area 871 and the received and paid money display area 872.

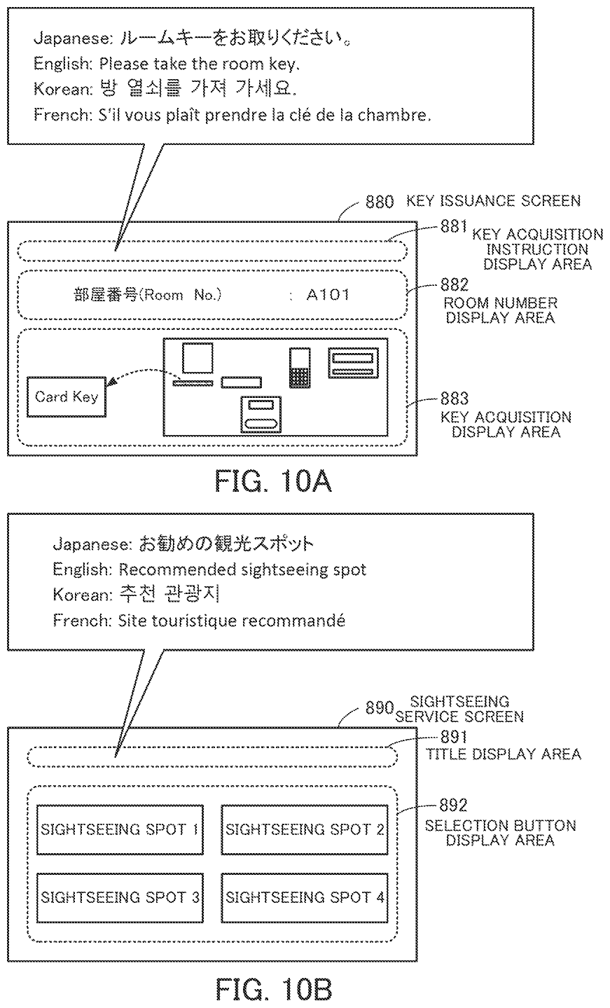

An example of a screen which the automatic payment machine 100 in the second embodiment displays will now be described by the use of FIGS. 10A and 10B. FIGS. 10A and 10B illustrate an example of a display screen on the automatic payment machine in the second embodiment (part 5).

FIG. 10A illustrates an example of a key issuance screen 880 displayed on the customer operation section 120 of the automatic payment machine 100. The key issuance screen 880 prompts the customer to receive a room key issued. The key issuance screen 880 includes a key acquisition instruction display area 881, a room number display area 882, and a key acquisition display area 883. The key acquisition instruction display area 881 includes display which prompts the customer to acquire the room key. For example, the sentence “Please take the room key.” is displayed on the key acquisition instruction display area 881. The room number display area 882 displays a room number. The key acquisition display area 883 displays a position in which the room key is ejected and a graphic explanation of the operation.

On the basis of the nationality acquired from the voice recognition language or the passport, a language is selected and displayed on the key acquisition instruction display area 881.

FIG. 10B illustrates an example of a sightseeing service screen 890 displayed on the customer operation section 120 of the automatic payment machine 100. The sightseeing service screen 890 provides sightseeing information to the customer who uses the automatic payment machine 100. The sightseeing service screen 890 includes a title display area 891 and a selection button display area 892. The title display area 891 displays a title of the sightseeing service screen 890. The title display area 891 may display not only a title but also another piece of information.

The selection button display area 892 displays buttons (sightseeing selection buttons) by which the customer selects sightseeing information. The selection button display area 892 displays buttons on which information, such as a sightseeing place and a sightseeing service, is displayed. The customer presses down a button on which information the customer wants to read is displayed. By doing so, information corresponding to the button pressed down is displayed.

On the basis of the nationality acquired from the voice recognition language or the passport, a language is selected and displayed on the title display area 891 and the selection button display area 892.

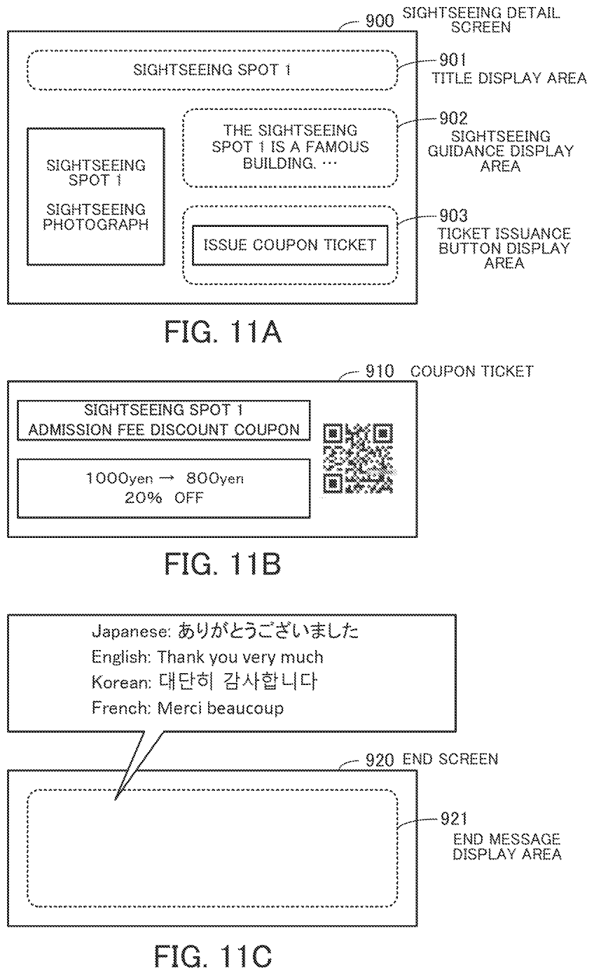

An example of a screen which the automatic payment machine 100 in the second embodiment displays and a coupon ticket which the automatic payment machine 100 in the second embodiment issues will now be described by the use of FIGS. 11A to 11C. FIGS. 11A to 11C illustrate an example of a display screen on the automatic payment machine in the second embodiment and a coupon ticket in the second embodiment.

FIG. 11A illustrates an example of a sightseeing detail screen 900 displayed on the customer operation section 120 of the automatic payment machine 100. The sightseeing detail screen 900 displays sightseeing information selected on the sightseeing service screen 890. The automatic payment machine 100 displays on the sightseeing detail screen 900 sightseeing information corresponding to a button the customer presses down on the selection button display area 892.

The sightseeing detail screen 900 includes a title display area 901, a sightseeing guidance display area 902, and a ticket issuance button display area 903.

The title display area 901 displays a title of the sightseeing detail screen 900. The title display area 901 may display not only a title but also another piece of information.

The sightseeing guidance display area 902 displays guidance of sightseeing information the customer selects. For example, the sentence “The sightseeing spot 1 is a famous building . . . ” is displayed on the sightseeing guidance display area 902.

The ticket issuance button display area 903 displays a ticket issuance button for issuing a coupon ticket corresponding to a sightseeing place and various pieces of information displayed on the sightseeing guidance display area 902. The automatic payment machine 100 detects that the ticket issuance button is pressed down, and issues a coupon ticket.

On the basis of the nationality acquired from the voice recognition language or the passport, a language is selected and displayed on the title display area 901, the sightseeing guidance display area 902, and the ticket issuance button display area 903.

FIG. 11B illustrates an example of a coupon ticket 910 the automatic payment machine 100 issues. If the automatic payment machine 100 detects that the ticket issuance button displayed on the ticket issuance button display area 903 is pressed down, then the automatic payment machine 100 issues the coupon ticket 910 from the card/receipt section 130. The coupon ticket 910 is not limited to a ticket on which character information indicative of an admission ticket or a discount ticket for a sightseeing place is printed, and includes various complimentary tickets and a ticket on which information (such as a uniform resource locator (URL), a bar code, or two-dimensional bar code) regarding access to a sightseeing site is printed.

FIG. 11C illustrates an example of an end screen 920 displayed on the customer operation section 120 of the automatic payment machine 100. The end screen 920 informs the customer who uses the automatic payment machine 100 of an end. The end screen 920 includes an end message display area 921. The end message display area 921 displays a message to the effect that a process by the automatic payment machine 100 ends. For example, the sentence “Thank you very much.” is displayed on the end message display area 921.

On the basis of the nationality acquired from the voice recognition language or the passport, a language is selected and displayed on the end message display area 921.

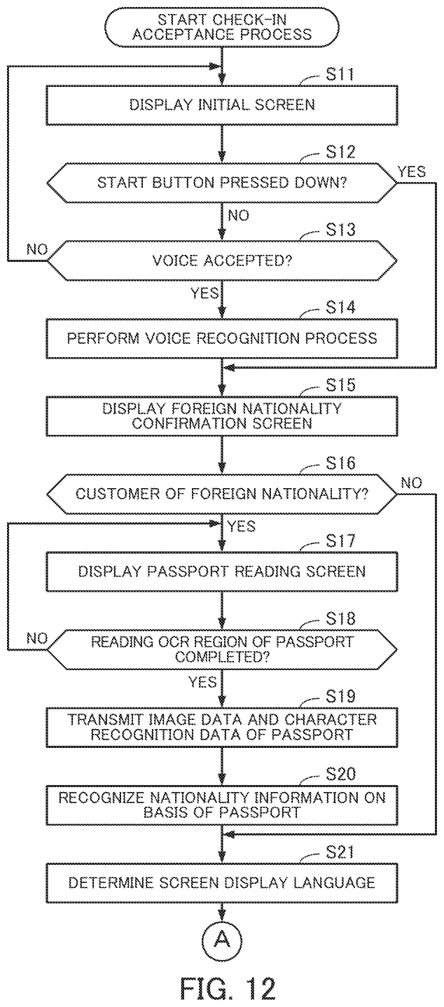

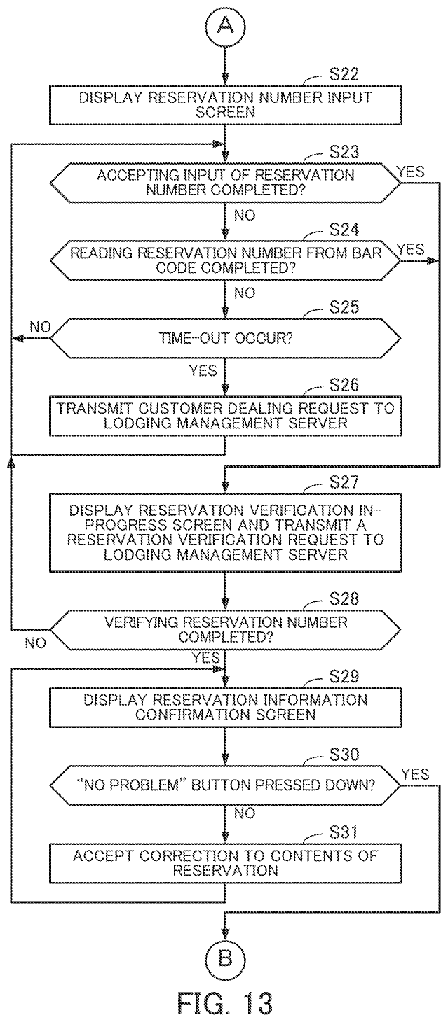

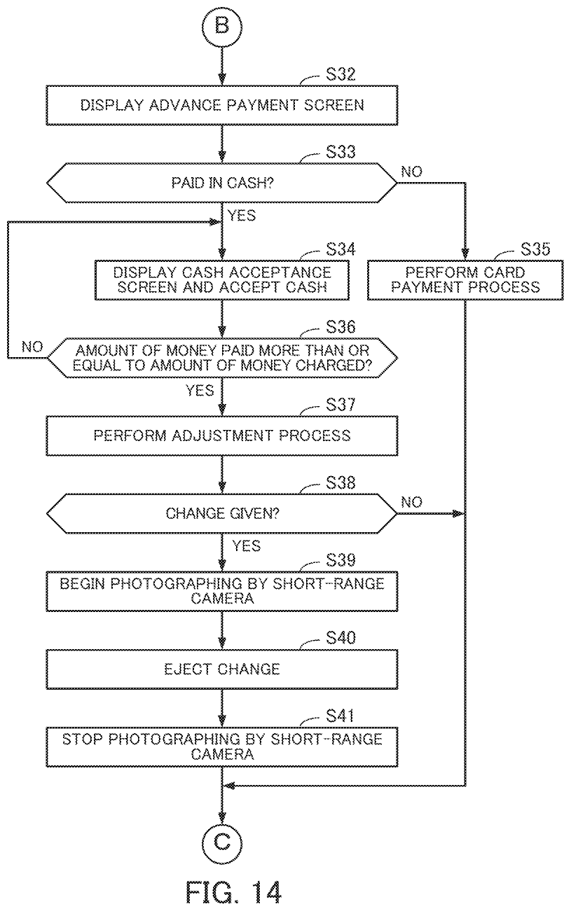

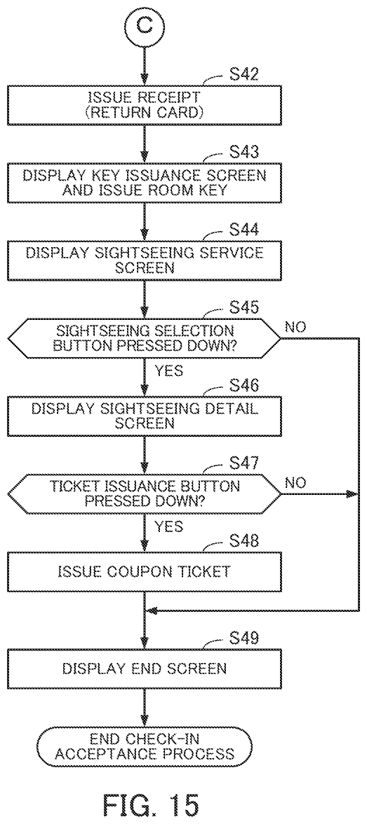

A check-in acceptance process the automatic payment machine 100 in the second embodiment performs will now be described by the use of FIGS. 12 through 15. FIG. 12 illustrates an example of a flow chart of a check-in acceptance process in the second embodiment (part 1). FIG. 13 illustrates an example of a flow chart of a check-in acceptance process in the second embodiment (part 2). FIG. 14 illustrates an example of a flow chart of a check-in acceptance process in the second embodiment (part 3). FIG. 15 illustrates an example of a flow chart of a check-in acceptance process in the second embodiment (part 4).

In a check-in acceptance process, the automatic payment machine 100 accepts a voice input or a button input from a customer, reads a passport, displays a screen according to a language recognized from the voice input or the passport, and issues a room key.

The control section 110 (processor 111) of the automatic payment machine 100 accepts a voice input or a button input from a customer and performs a check-in acceptance process.

(Step S11) The control section 110 displays the initial screen 800 on the display 120a.

(Step S12) The control section 110 determines whether or not a start button displayed on the start button display area 803 is pressed down via the touch panel 120b. If a start button is pressed down, then the control section 110 proceeds to step S15. If a start button is not pressed down, then the control section 110 proceeds to step S13.

(Step S13) The control section 110 determines whether or not a voice is accepted via the voice processing unit 195a. If a voice is accepted, then the control section 110 proceeds to step S14. If a voice is not accepted, then the control section 110 proceeds to step S11.

(Step S14) On the basis of the voice accepted in step S13, the control section 110 performs a voice recognition process and determines a language (voice recognition language) the customer uses. For example, if the voice “Bonjour” is accepted in French, then the control section 110 determines French as a voice recognition language.

(Step S15) The control section 110 displays the foreign nationality confirmation screen 810 on the display 120a.

(Step S16) The control section 110 determines whether or not a button which is displayed on the answer button display area 812 and which is indicative that the customer is of foreign nationality is pressed down via the touch panel 120b. If a button which is indicative that the customer is of foreign nationality is pressed down, then the control section 110 proceeds to step S17. If a button which is indicative that the customer is not of foreign nationality is pressed down, then the control section 110 proceeds to step S21.

(Step S17) The control section 110 displays the passport reading screen 820 on the display 120a.

(Step S18) The control section 110 acquires an image of a passport via the passport processing unit 180a, performs character recognition on an OCR region of the passport, and determines whether or not reading the passport is completed. If reading the passport is completed, then the control section 110 proceeds to step S19. If reading the passport is not completed, then the control section 110 returns to step S17.

(Step S19) The control section 110 transmits to the lodging management server 300 image data and character recognition data of the passport. The lodging management server 300 stores in a storage unit, such as the HDD 313, the image data and the character recognition data received from the control section 110.

(Step S20) The control section 110 recognizes nationality information on the basis of the character recognition data acquired from the passport. For example, if the character recognition data indicate Canadian nationality, then the control section 110 determines the customer's nationality as Canada.

(Step S21) The control section 110 determines a screen display language. If the voice recognition language and a language based on the nationality do not match, then the control section 110 determines a screen display language by giving priority to the voice recognition language.

The automatic payment machine 100 stores in advance in a storage unit, such as the HDD 113, information (nationality language association information) which associates a nationality with a language. Accordingly, it is assumed that the control section 110 specifies one or more languages on the basis of the nationality acquired from the passport. For example, it is assumed that the nationality “Japan” is associated with the language “Japanese” in the nationality language association information (not illustrated).

If the voice recognition language and a language based on the nationality do not match, then the control section 110 may perform display in both languages. For example, if the voice recognition language is “English” and a language based on the nationality is “Japanese,” then the control section 110 may perform display both in “English” and in “Japanese”.

Furthermore, if there are two or more languages based on the nationality (if there are two or more official languages in a country), then the control section 110 may display a plurality of languages as languages based on the nationality. For example, if the voice recognition language is “Japanese,” the nationality is “Canada,” and languages based on the nationality are “English and French,” then the control section 110 may display the three languages, that is to say, “Japanese,” “English,” and “French” together. The control section 110 becomes multilingual in this way. It is assumed that as the number of languages to be displayed increases, the control section 110 changes the display area of each screen to scroll display.

(Step S22) The control section 110 displays the reservation number input screen 830 on the display 120a. In addition to the sentence “Please enter the reservation number,” the control section 110 may display the sentence “Or please display a bar code by a reservation application in your smartphone and hold it over the passport reading section” on the input instruction display area 831.

If it is possible for the control section 110 to verify lodging reservation on the basis of information acquired from the passport, then the control section 110 may omit step S22 through step S26.

(Step S23) The control section 110 determines whether or not accepting an input of the reservation number via the touch panel 120b is completed. If accepting an input of the reservation number is completed, then the control section 110 proceeds to step S27. If accepting an input of the reservation number is not completed, then the control section 110 proceeds to step S24.

The control section 110 stores in advance in a storage unit a determined digit number as the digit number of the reservation number. If a number inputted reaches the determined digit number, then the control section 110 determines that accepting an input of the reservation number is completed.

(Step S24) The control section 110 reads via the passport processing unit 180a a bar code displayed on the customer terminal 200, and determines whether or not reading the reservation number from the bar code is completed. If reading the reservation number from the bar code is completed, then the control section 110 proceeds to step S27. If reading the reservation number from the bar code is not completed, then the control section 110 proceeds to step S25.

(Step S25) The control section 110 determines whether or not a time-out occurs. When determined time (three minutes, for example) elapses from the time when the control section 110 displays the reservation number input screen 830, the control section 110 determines that a time-out occurs. If a time-out occurs, then the control section 110 proceeds to step S26. If a time-out does not occur, then the control section 110 returns to step S23.

(Step S26) The control section 110 transmits a customer dealing request to the lodging management server 300 and returns to step S23. The control section 110 transmits the voice recognition language, the nationality information, and payment machine identification information, together with the customer dealing request. If the control section 110 has not read the passport, then the control section 110 does not transmit the nationality information.

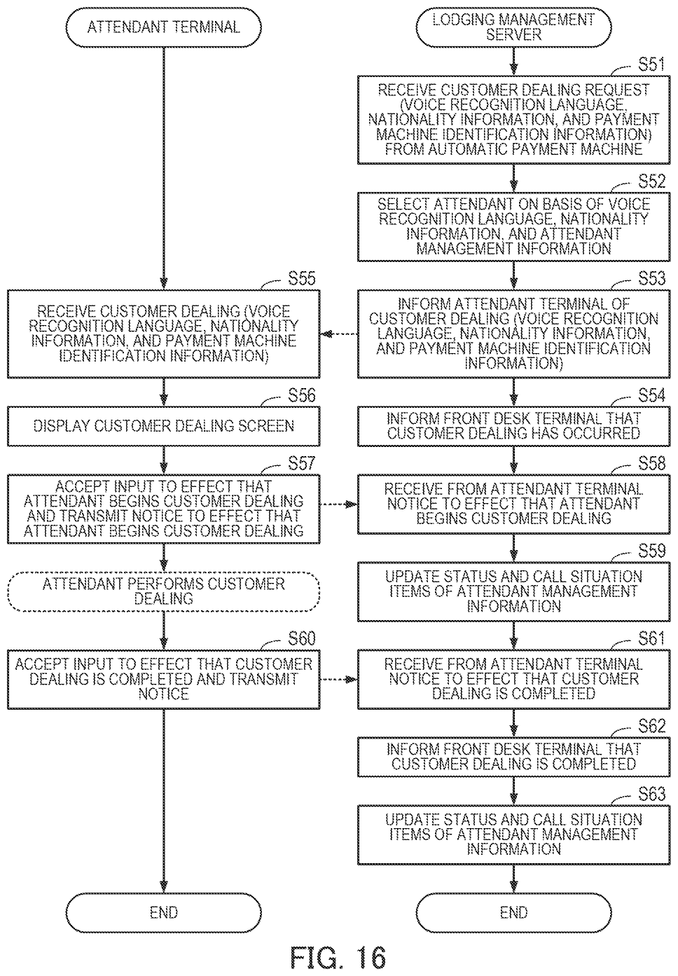

A process in which the lodging management server 300 receives the customer dealing request from the control section 110 and in which the lodging management server 300 informs the attendant terminal 210 of customer dealing will be described later by the use of FIG. 16.

(Step S27) The control section 110 displays the reservation verification in-progress screen 840 on the display 120a and transmits the reservation number, together with a reservation verification request, to the lodging management server 300.

(Step S28) The control section 110 determines whether or not it receives from the lodging management server 300 notice to the effect that verifying the reservation number is completed. If the control section 110 receives from the lodging management server 300 notice to the effect that verifying the reservation number is completed, then the control section 110 proceeds to step S29. If the control section 110 receives from the lodging management server 300 notice to the effect that it is impossible to verify the reservation number, then the control section 110 returns to step S23.

If the control section 110 receives from the lodging management server 300 the notice to the effect that it is impossible to verify the reservation number, then the control section 110 displays the sentence “Please enter the reservation number again.” and the reservation number input screen 830 on the display 120a and returns to step S23.

The control section 110 receives from the lodging management server 300 reservation information, together with the notice to the effect that verifying the reservation number is completed.

(Step S29) The control section 110 displays the reservation information confirmation screen 850 on the display 120a. The control section 110 displays on the reservation information display area 852 the reservation information received from the lodging management server 300.

(Step S30) The control section 110 determines whether or not the “No Problem” button displayed on the answer button display area 853 is pressed down via the touch panel 120b. If the “No Problem” button is pressed down, then the control section 110 proceeds to step S32. If the “Problem Detected (to Correction Screen)” button displayed on the answer button display area 853 is pressed down, then the control section 110 proceeds to step S31.

(Step S31) The control section 110 accepts a correction to the contents of the reservation for the lodging in the lodging facility. To be concrete, the control section 110 displays a reservation correction screen on the display 120a, accepts the contents of the correction via the touch panel 120b, transmits the contents of the correction accepted to the lodging management server 300, and returns to step S29. The lodging management server 300 receives the contents of the correction from the control section 110 and stores them in a storage unit.

(Step S32) The control section 110 displays the advance payment screen 860 on the display 120a.

If the customer has transferred in advance hotel charges and the like from a bank or the like and there is no need for the customer to pay the hotel charges and the like by the use of the automatic payment machine 100, then the control section 110 may omit step S32 through step S41.

(Step S33) The control section 110 determines whether or not the hotel charges and the like are paid in cash. To be concrete, the control section 110 determines whether or not the “Cash” button displayed on the selection button display area 863 is pressed down via the touch panel 120b. If the “Cash” button is pressed down, then the control section 110 proceeds to step S34. If the “Credit” button displayed on the selection button display area 863 is pressed down, then the control section 110 proceeds to step S35.

(Step S34) The control section 110 displays the cash acceptance screen 870 on the display 120a and accepts cash via the banknote processing unit 160a and the coin processing unit 170a. The control section 110 displays the amount of the cash accepted via the banknote processing unit 160a and the coin processing unit 170a as the amount of money paid on the received and paid money display area 872.

(Step S35) The control section 110 displays on the display 120a a screen which explains the operation of accepting a card, and accepts a card via the card/receipt processing unit 130a. The control section 110 transmits information regarding the accepted card to the payment server 500 to perform a card payment process.

(Step S36) The control section 110 determines whether or not the amount of the cash paid in step S34 (amount of money paid) is more than or equal to the amount of money charged. If the amount of money paid is more than or equal to the amount of money charged, then the control section 110 proceeds to step S37. If the amount of money paid is not more than or equal to the amount of money charged, then the control section 110 returns to step S34.

(Step S37) The control section 110 performs a change calculation. To be concrete, the control section 110 subtracts the amount of money charged from the amount of money paid to calculate the amount of change.

(Step S38) If change is given, then the control section 110 proceeds to step S39. If change is not given, then the control section 110 proceeds to step S42.

(Step S39) The control section 110 begins photographing by the short-range camera included in the banknote processing section 160.

(Step S40) The control section 110 ejects the change via the banknote processing unit 160a and the coin processing unit 170a.

(Step S41) The control section 110 stops photographing by the short-range camera included in the banknote processing section 160.

(Step S42) The control section 110 prints via the card/receipt processing unit 130a the amount of money received, the amount of money paid, the reservation information, and the like on a receipt, ejects the receipt from the card/receipt section 130, and issues the receipt.

If the “Credit” button is pressed down and the control section 110 accepts the card, then the control section 110 ejects the card via the card/receipt processing unit 130a and returns the card to the customer.

(Step S43) The control section 110 displays the key issuance screen 880 on the display 120a and issues a room key via the room key processing unit 140a. On the basis of the reservation information received from the lodging management server 300, the control section 110 performs setting to make a key card available for a lodging period (dates of the check-in and check-out) of the customer and the number of a room at which the customer lodges.

(Step S44) The control section 110 displays the sightseeing service screen 890 on the display 120a.

(Step S45) The control section 110 determines whether or not it detects that a sightseeing selection button displayed on the selection button display area 892 is pressed down. If the control section 110 detects that a sightseeing selection button displayed on the selection button display area 892 is pressed down, then the control section 110 proceeds to step S46. If the control section 110 does not detect that a sightseeing selection button displayed on the selection button display area 892 is pressed down, then the control section 110 proceeds to step S49.

(Step S46) The control section 110 displays the sightseeing detail screen 900 on the display 120a.

(Step S47) The control section 110 determines whether or not it detects that the ticket issuance button displayed on the ticket issuance button display area 903 is pressed down. If the control section 110 detects that the ticket issuance button displayed on the ticket issuance button display area 903 is pressed down, then the control section 110 proceeds to step S48. If the control section 110 does not detect that the ticket issuance button displayed on the ticket issuance button display area 903 is pressed down, then the control section 110 proceeds to step S49.

(Step S48) The control section 110 prints a coupon ticket 910 by the card/receipt processing unit 130a, ejects the coupon ticket 910 from the card/receipt processing unit 130a, and issues the coupon ticket 910.

(Step S49) The control section 110 displays the end screen 920 on the display 120a and ends the process.

An attendant notification process performed in the information processing system 600 according to the second embodiment will now be described by the use of FIG. 16. FIG. 16 illustrates an example of a sequence of an attendant notification process in the second embodiment.

In an attendant notification process, the lodging management server 300 accepts a customer dealing request from the automatic payment machine 100, selects an attendant, informs the attendant terminal 210 of customer dealing, and updates the attendant management information 700. The control section 310 (processor 311) of the lodging management server 300 receives the customer dealing request from the automatic payment machine 100 and performs the attendant notification process.

A process performed by the attendant terminal 210 is performed by a control section (processor) included in the attendant terminal 210. A process performed by the automatic payment machine 100 is performed by the control section 110 (processor 111) included in the automatic payment machine 100. A process performed by the lodging management server 300 is performed by the control section 310 (processor 311) included in the lodging management server 300.

(Step S51) The lodging management server 300 receives from the automatic payment machine 100 the voice recognition language, the nationality information, and payment machine identification information, together with the customer dealing request.

(Step S52) The lodging management server 300 selects an attendant who performs customer dealing on the basis of the received voice recognition language and nationality information and the attendant management information 700. For example, the lodging management server 300 selects an attendant who meets the following (condition 1) through (condition 3) in that order. (Condition 1) An attendant who is able to handle a language based on the voice recognition language and the nationality. (Condition 2) An attendant who is able to handle the voice recognition language. (Condition 3) An attendant who is able to handle a language based on the nationality. First the lodging management server 300 selects an attendant who meets (condition 1). However, if it is impossible for an attendant who meets (condition 1) to perform customer dealing, then the lodging management server 300 selects an attendant who meets (condition 2). Furthermore, if it is impossible for an attendant who meets (condition 2) to perform customer dealing, then the lodging management server 300 selects an attendant who meets (condition 3).

(Step S53) The lodging management server 300 informs the attendant terminal 210 of the voice recognition language, the nationality information, and the payment machine identification information, together with customer dealing. This step will now be described. In this step, a case where a language used by the customer does not correspond to a language based the nationality on a one-to-one basis is taken into consideration. The following (example 1) and (example 2) are taken as examples of the case where a language used by the customer does not correspond to a language based the nationality on a one-to-one basis. (Example 1) The customer returns from an English-speaking country and uses not a native language in the country of the customer's nationality but English. (Example 2) There are a plurality of official languages in the country of the customer's nationality.

Before the attendant deals with the customer, the attendant grasps the voice recognition language and the nationality information by the use of the attendant terminal 210. By doing so, the attendant heads toward the automatic payment machine 100 for which the attendant performs customer dealing, while making preparations (such as preparing an explanatory note corresponding to a language used by the customer and setting a language for translation software) for the customer dealing. This improves customer services.

It is assumed that the lodging management server 300 stores in advance in a storage unit management information which associates attendant ID with a notification destination address of the attendant terminal 210 and that the lodging management server 300 communicates with the attendant terminal 210 which the attendant corresponding to the selected attendant ID holds.

(Step S54) The lodging management server 300 informs the front desk terminal 400 that the customer dealing has occurred. The lodging management server 300 informs the front desk terminal 400 of the attendant ID, the payment machine identification information, the voice recognition language, and the nationality information. The front desk terminal 400 receives the information of which the lodging management server 300 informs the front desk terminal 400, and displays the information. As a result, an attendant who uses the front desk terminal 400 grasps a situation where the customer dealing has occurred for the automatic payment machine 100.

(Step S55) The attendant terminal 210 receives from the lodging management server 300 the voice recognition language, the nationality information, and the payment machine identification information, together with the customer dealing.

(Step S56) The attendant terminal 210 displays the information received from the lodging management server 300 on a display of the attendant terminal 210 as a customer dealing screen.

The attendant views the customer dealing screen and grasps the voice recognition language and the nationality information of the customer and the payment machine identification information of the automatic payment machine 100 for which the attendant performs the customer dealing.

(Step S57) The attendant terminal 210 accepts from the attendant an input to the effect that the attendant begins the customer dealing, and transmits to the lodging management server 300 notice to the effect that the attendant begins the customer dealing. It is assumed that the attendant terminal 210 includes an input acceptance section such as a touch panel, that an interface which accepts an input is presented on the customer dealing screen displayed in step S56, and that an input from the attendant is accepted.

The attendant visually confirms the payment machine identification information displayed on the attendant terminal 210, heads toward the automatic payment machine 100 for which the attendant performs the customer dealing, and performs the customer dealing.

(Step S58) The lodging management server 300 receives from the attendant terminal 210 the notice to the effect that the attendant begins the customer dealing.

(Step S59) The lodging management server 300 updates the Status and Call Situation items of the attendant management information 700. To be concrete, the lodging management server 300 registers the payment machine identification information of the automatic payment machine 100 which transmits the customer dealing request in the Status item corresponding to the attendant ID of the attendant informed of the customer dealing. Furthermore, the lodging management server 300 registers the date and hour at which the lodging management server 300 receives the customer dealing request in step S51 in the Date and Hour subitem of the Call Situation item corresponding to the attendant ID of the attendant informed of the customer dealing. In addition, the lodging management server 300 registers the voice recognition language and the nationality information the lodging management server 300 receives in step S51 in the Voice Recognition Language and Nationality subitems, respectively, of the Call Situation item corresponding to the attendant ID of the attendant informed of the customer dealing.

(Step S60) The attendant terminal 210 accepts an input to the effect that the customer dealing is completed, and transmits to the lodging management server 300 notice to the effect that the customer dealing is completed.

(Step S61) The lodging management server 300 receives from the attendant terminal 210 the notice to the effect that the customer dealing is completed.

(Step S62) The lodging management server 300 informs the front desk terminal 400 that the customer dealing is completed, and ends the process. The front desk terminal 400 receives the information of which the lodging management server 300 informs the front desk terminal 400, and displays the information. As a result, an attendant who uses the front desk terminal 400 grasps that the customer dealing for the automatic payment machine 100 is completed.

(Step S63) The lodging management server 300 updates the Status and Call Situation items of the attendant management information 700 and ends the process. To be concrete, the lodging management server 300 registers “-” in the Status item and the Date and Hour, Voice Recognition Language, and Nationality subitems corresponding to the attendant ID of the attendant informed of the customer dealing.

The process performed by the lodging management server 300 and described in FIG. 16 may be performed by the automatic payment machine 100. If the automatic payment machine 100 performs the process by the lodging management server 300 included in the attendant notification process, then it is assumed that the attendant management information 700 is stored in a storage unit (such as the HDD 113 or a database (not illustrated) connected to the network 610) the automatic payment machine 100 is able to access. Furthermore, if the automatic payment machine 100 performs the process by the lodging management server 300 included in the attendant notification process, then step S51 is omitted.

As has been described, the automatic payment machine 100 and the information processing system 600 perform customer dealing on the basis of a voice recognition language based on a voice a customer makes and nationality information read from a passport.

As the number of foreign tourists increases, in recent years the number of customers' national origins has increased. As a result, the number of types of languages to be handled in lodging facilities increases. Even if the automatic payment machine 100 stores in a storage unit a dictionary of each country, example sentences, and the like, all the languages or all the country names are not displayed on a screen of the customer operation section 120 because the number of the languages is large. In view of this situation, the automatic payment machine 100 realizes screen display on the basis of a language recognized from a voice a customer makes and a language based on a nationality acquired by reading a passport. This improves the convenience of customers.

The information processing system 600 and the lodging management server 300 become multilingual in this way.

The above processing functions are realized with a computer. In that case, a program in which the contents of the function that the automatic payment machine 10 or 100, the customer terminal 200, the attendant terminal 210, the lodging management server 300, the front desk terminal 400, or the payment server 500 has are described is provided. The above processing functions are realized on the computer by executing the program by the computer. The program in which the contents of the function are described is recorded in a computer-readable record medium. The computer-readable record medium is magnetic storage, an optical disc, an optical magnetic record medium, a semiconductor memory, or the like. Magnetic storage is a hard disk drive (HDD), a flexible disk (FD), a magnetic tape, or the like. An optical disc is a DVD, a DVD-RAM, a compact disc read only memory (CD-ROM)/rewritable (RW), or the like. An optical magnetic record medium is an MO or the like.

For example, a portable record medium, such as a DVD or a CD-ROM, on which the program is recorded is sold in order to circulate the program. Furthermore, the program is stored in advance in a storage unit of a server computer and is transferred via a network from the server computer to another computer.

For example, a computer which executes the program stores in its storage unit the program recorded on a portable record medium or transferred from the server computer. The computer reads the program from its storage unit and performs a process in accordance with the program. The computer may read the program directly from the portable record medium and perform a process in accordance with the program. In addition, each time the program is transferred from the server computer connected via the network, the computer may perform a process in accordance with the received program.

Furthermore, at least part of the above processing functions may be realized by an electronic circuit such as a DSP, an ASIC, or a PLD.

According to an aspect, many languages are handled.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that various changes, substitutions, and alterations could be made hereto without departing from the spirit and scope of the disclosure.

What is claimed is:

1. An automatic payment machine comprising:
a voice interface configured to accept an input by a voice from a user and configured to acquire voice data;
a reader configured to read a passport, configured to acquire image data, and configured to acquire character information from the image data;
a display panel configured to display a screen and which accepts an input;
a key issuing interface configured to issue a room key; and
a processor configured to perform a process including:
specifying a voice recognition language corresponding to the voice on a basis of the voice data, specifying a nationality associated language corresponding to a nationality included in the character information, giving the display panel, on a basis of the voice recognition language and the nationality associated language, instructions to perform a display, and giving the key issuing interface, on a basis of the character information, the input the display panel accepts, or an input the reader accepts, instructions to issue the room key.

2. The automatic payment machine according to claim 1, wherein the process further includes transmitting to an information processing apparatus a request to verify reservation information of the user on a basis of a reservation number the display panel accepts as the input, a reservation number read from a bar code the reader reads, or information including at least one of a passport number, the nationality, a name, and a date of birth included in the character information.

3. The automatic payment machine according to claim 2, wherein the process further includes paying costs incurred on a basis of the reservation information.

4. The automatic payment machine according to claim 1, wherein the process further includes giving the display panel instructions to display a screen in the voice recognition language, in the nationality associated language, in the voice recognition language and the nationality associated language, or in the voice recognition language or the nationality associated language.

5. The automatic payment machine according to claim 1, wherein the process further includes selecting, responsive to an elapse of a determined time at a time of the display panel accepting the input, an attendant who deals with the user on a basis of the voice recognition language and the nationality.

6. The automatic payment machine according to claim 5, wherein the process further includes transmitting the voice recognition language, the nationality, and an identification information of the automatic payment machine to a terminal the attendant uses.

7. The automatic payment machine according to claim 1, further comprising a ticket issuance interface configured to issue a coupon ticket,
wherein the process further includes:
giving the display panel instructions, on a basis of the voice recognition language and the nationality associated language, to display a guidance screen; and
giving the ticket issuance interface instructions to issue the coupon ticket regarding information, of information displayed on the guidance screen, selected via the display panel.

8. An automatic payment machine control method for an automatic payment machine, wherein:
the automatic payment machine includes a voice interface, a reader, a display panel, a key issuing interface, and a processor; and
the automatic payment machine control method includes:
accepting, by the voice interface, an input by a voice from a user and acquiring voice data,
reading, by the reader, a passport, acquiring image data, and acquiring character information from the image data, and
specifying, by the processor, a voice recognition language corresponding to the voice on a basis of the voice data, specifying a nationality associated language corresponding to a nationality included in the character information, giving the display panel, on a basis of the voice recognition language and the nationality associated language, instructions to perform a display, and giving the key issuing interface, on a basis of the character information, an input the display panel accepts, or an input the reader accepts, instructions to issue a room key.
